(19) United States
(12) Patent Application Publication
(10) Pub. No.: US 2024/0267802 A1
(43) Pub. Date: Aug. 8, 2024

(54) MEASUREMENT AND REPORTING FOR MOBILITY ENHANCEMENT

(71) Applicant: ZTE Corporation, Shenzhen (CN)

(72) Inventors: Ling YANG, Shenzhen (CN); Bo GAO, Shenzhen (CN); Shujuan ZHANG, Shenzhen (CN); Ke YAO, Shenzhen (CN); Yang ZHANG, Shenzhen (CN); Zhaohua LU, Shenzhen (CN)

(21) Appl. No.: 18/533,677

(22) Filed: Dec. 8, 2023

Related U.S. Application Data
(63) Continuation of application No. PCT/CN2022/107145, filed on Jul. 21, 2022.

(51) Int. Cl. H04W 36/00

(52) U.S. Cl. CPC H04W 36/0072; H04W 36/0061; H04W 36/0085

(57) ABSTRACT

Methods, apparatus, and systems that relate to reference signal measurement and reporting at a lower layer to enable fast cell switching include a method for wireless communication includes transmitting, by a network node, configuration information about one or more candidate targets to a terminal device to enable a measurement or a reporting of the one or more candidate targets, e.g., at a layer that is lower than the network layer. The configuration information comprises at least one of measurement configuration or reporting configuration about the one or more candidate targets, the configuration information further comprising inter-frequency information.

### TECHNICAL FIELD

This patent document is directed to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques related to reference signal measurement and reporting at a lower layer to enable fast mobility events.

In one example aspect, a method for wireless communication includes transmitting, by a network node, configuration information about one or more candidate targets to a terminal device to enable a measurement or a reporting of the one or more candidate targets, e.g., at a layer that is lower than the network layer. The configuration information comprises at least one of measurement configuration or reporting configuration about the one or more candidate targets, the configuration information further comprising inter-frequency information.

In another example aspect, a method for wireless communication includes determining, by a terminal device, configuration information from a network node. The configuration information includes at least one of measurement configuration or reporting configuration about one or more candidate targets. The configuration information further comprises inter-frequency information. The method also includes performing a measurement or a reporting of the one or more candidate gargets at a layer that is lower than the network layer.

In another example aspect, a communication apparatus is disclosed. The apparatus includes a processor that is configured to implement an above-described method.

In yet another example aspect, a computer-program storage medium is disclosed. The computer-program storage medium includes code stored thereon. The code, when executed by a processor, causes the processor to implement a described method.

These, and other, aspects are described in the present document.

### BRIEF DESCRIPTION OF DRAWINGS

FIG. 1 illustrates an example user plane protocol stack in radio protocol architecture.

FIG. 2A illustrates a method for wireless communication in accordance with one or more embodiments of the present technology.

FIG. 2B illustrates another method for wireless communication in accordance with one or more embodiments of the present technology.

FIG. 3A illustrates an example diagram of associating a reference signal (RS) with the identification information in accordance with one or more embodiments of the present technology.

FIG. 3B illustrates an example diagram of associating an RS with at least one of the identification information and inter-frequency measurement information in accordance with one or more embodiments of the present technology.

FIG. 3C illustrates an example diagram of associating an RS set with the identification information in accordance with one or more embodiments of the present technology.

FIG. 3D illustrates another example diagram of associating an RS set with a list of identification information in accordance with one or more embodiments of the present technology.

FIG. 3E illustrates an example diagram of associating an RS set with at least one of the identification information and inter-frequency measurement information in accordance with one or more embodiments of the present technology.

FIG. 3F illustrates another example diagram of associating an RS set with at least one of a list of the identification information and inter-frequency measurement information in accordance with one or more embodiments of the present technology.

FIG. 3G illustrates another example diagram of associating an RS set with at least one of a list of the identification information and a list of inter-frequency measurement information in accordance with one or more embodiments of the present technology.

FIG. 4A illustrates an example diagram of associating a Transmission Configuration Indicator (TCI) state with the identification information in accordance with one or more embodiments of the present technology.

FIG. 4B illustrates an example diagram of associating a TCI state with at least one of the identification information and inter-frequency measurement information in accordance with one or more embodiments of the present technology.

FIG. 5A illustrate an example of including at least one of identification information corresponding to candidate target and inter-frequency information in one or more different levels of Information Element (IEs) in accordance with one or more embodiments of the present technology.

FIG. 5B illustrate another example of one or more different levels of IEs included in one or more candidate targets in accordance with one or more embodiments of the present technology.

FIG. 6 shows an example of a wireless communication system where techniques in accordance with one or more embodiments of the present technology can be applied.

FIG. 7 is a block diagram representation of a portion of a radio station in accordance with one or more embodiments of the present technology can be applied.

### DETAILED DESCRIPTION

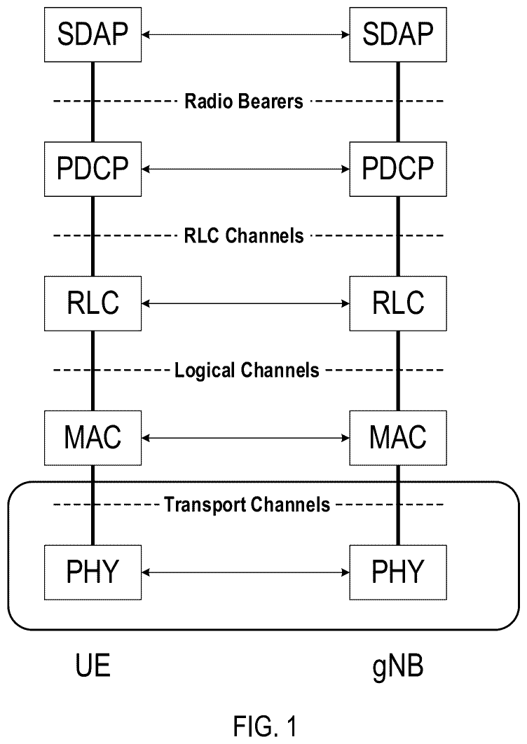

In Long-Term Evolution (LTE) and Fifth Generation (5G) wireless communications, the network includes the following protocol entities: the Service Data Adaptation Protocol (SDAP), the Packet Data Convergence Protocol (PDCP), the Radio Link Control (RLC), the Medium Access Control (MAC), and the Physical Layer (PHY). FIG. 1 illustrates an example user plane protocol stack in radio protocol architecture. For example, the Radio Resource Control (RRC) protocol used in wireless communication is a Layer 3 (L3) protocol between a User Equipment (UE) and the base station. The MAC sublayer and the RLC sublayer are referred to as Layer 2 (L2). The PHY layer is referred to as Layer 1 (L1).

With the development of wireless technology, the UE can move from one cell to another more often and more swiftly. For such UE mobility events, a change of the serving cell is needed to provide quality services. Currently, a serving cell change is triggered by L3 measurements. The change of the serving cell is completed using RRC signaling, such as RRC Reconfiguration for the change of the primary cell (PCell) and/or the primary serving cell (PSCell) as well as the release and/or addition for secondary cells (SCells). Changes at the L3 level, however, involve complete L1 and L2 reset. In particular, L1 measurement on Synchronization Signal Block (SSB) or periodic Channel State Information Reference Signal (CSI-RS) cannot be triggered in a dynamic manner, leading to longer latency, larger overhead, and longer interruption time.

This patent discloses techniques that can be implemented in various embodiments for configuration measurement resources and/or reporting to enable serving cell changes at a lower layer (e.g., L1/L2), thereby reducing the latency, overhead, and interruption time in UE mobility events.

The UE performs measurements of reference signals and report the measurements to the network to indicate the network conditions (e.g., the channel state). Before the UE can perform measurements, it needs to be configured with appropriate measurement resources corresponding to the reference signal(s) from at least one target. The reference signal(s) can be at least one of SSB, CSI-RS, Tracking Reference Signal (TRS), Sounding Reference Signal (SRS), Demodulation Reference Signal (DMRS), and other types of reference signals. The at least one target can be one of a Transmission/Reception Point (TRP), a panel, a port, a cell, a Distributed Unit (DU), a Centralized Unit (CU), a Component Carrier (CC), a Bandwidth Part (BWP), or other types of potential targets.

For measurement resources and/or configurations, at least one of the following methods can be considered:

Method-1: Measurement resources and/or configurations are pre-configured/pre-defined or be determined based on L3 configuration (e.g., RRC signaling).

Method-2: A set of measurement resources and/or configurations is pre-configured/pre-defined or is first determined based on L3 configuration (e.g., RRC signaling). One or more subsets of the measurement resources and/or configurations are then activated/deactivated. For example, the one or more subsets can be activated/deactivated by a L1/L2 signaling, such as a MAC Control Element (CE) or a Downlink Control Information (DCI) signaling. As another example, the one or more subsets can be determined based on measurement results, such as current or prior measurement results associated with a cell (e.g., the current serving cell), historic measurement results associated with multiple cells. In some embodiments, the determination of the one or more subsets can also be associated with UE capability. In some embodiments, one or more subsets of the measurement resources and/or configurations can be initially selected and then be updated, if needed, via the MAC CE/DCI signaling or based on the measurement results and/or UE capability.

Method-3: A set of measurement resources and/or configurations is pre-configured/pre-defined or is first determined based on L3 configuration (e.g., RRC signaling). Whether to active or deactivate the set of the configured measurement resources/configurations depends on measurement results from serving cell. For example, if the measurement result from serving cell satisfies a specific condition (e.g., exceeding a predefined threshold), UE can report the result to network and receive an indication to active or deactivate the set of configured measurement resources and/or configurations. The indication can be a MAC CE or DCI signaling. As another example, an event occurs when the measurement result from serving cell satisfies a specific condition (e.g., being equal to or greater than a threshold). The set of configured measurement resources/configurations is triggered (e.g., activated or deactivated) by the event.

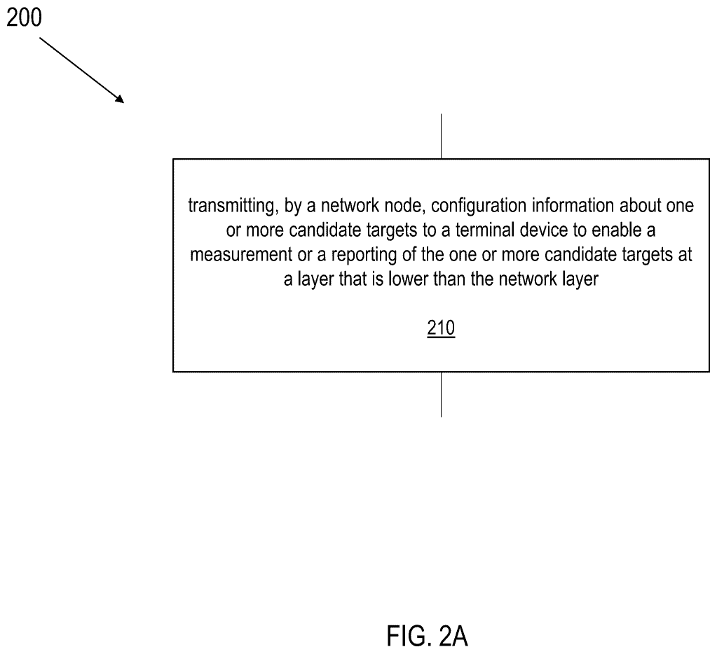

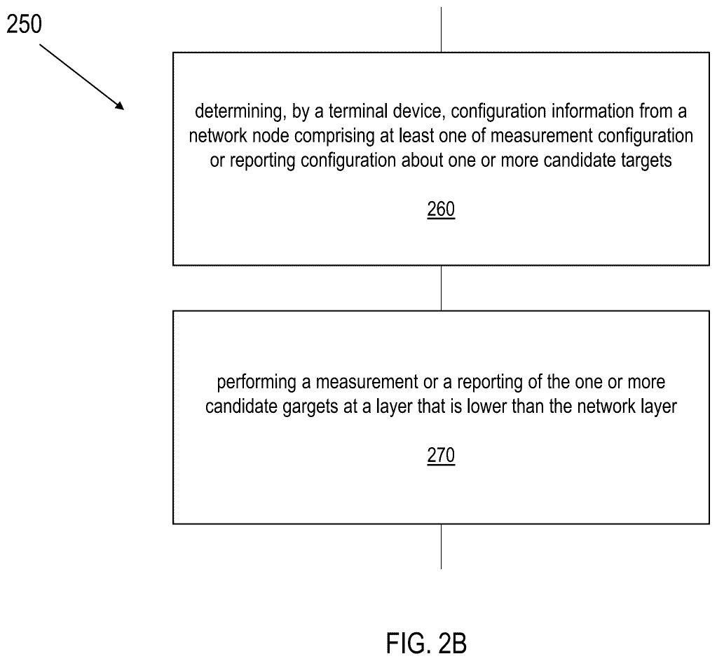

FIG. 2A illustrates a method 200 for wireless communication in accordance with one or more embodiments of the present technology. The method 200 includes, at operation 210, transmitting, by a network node, configuration information about one or more candidate targets to a terminal device to enable a measurement or a reporting of the one or more candidate targets at a layer that is lower than the network layer. The configuration information comprises at least one of measurement configuration or reporting configuration about the one or more candidate targets, the configuration information further comprising inter-frequency information.

FIG. 2B illustrates a method for wireless communication in accordance with one or more embodiments of the present technology. The method 250 includes, at operation 260, determining, by a terminal device, configuration information from a network node. The configuration information includes at least one of measurement configuration or reporting configuration about one or more candidate targets. The configuration information further comprises inter-frequency information. The method 250 also includes, at operation 270, performing a measurement or a reporting of the one or more candidate gargets at a layer that is lower than the network layer.

In some embodiments, the measurement configuration, the one or more candidate targets, and/or the reporting configuration can be activated, deactivated, or updated using a signaling message. In some embodiments, the configuration information about the one or more candidate targets is included in (1) a reference signal (RS) or RS set configuration, a Transmission Configuration Indicator (TCI) state or a parameter that is related to TCI state, (3) a control resource set, (4) a physical downlink control channel configuration, (5) a physical downlink shared channel configuration, (6) a bandwidth part (BWP) configuration, (7) a channel state information measurement configuration, (8) a serving cell configuration, or (9) a cell group configuration.

In some embodiments, reporting of the one or more candidate targets is initiated or terminated upon an occurrence of an event or when a condition is satisfied. In some embodiments, a first timer is used to terminate the reporting and/or a second timer is used to started or re-started the reporting. A time-domain granularity of the first timer or the second timer comprises one of: a symbol, a slot, a subframe, a frame, a nanosecond, a microsecond, a millisecond, or a second.

Some examples of the disclosed techniques are further described below.

### Embodiment 1

In some embodiments, the configured measurement resources/configurations are associated with corresponding targets (e.g., one or more of the candidate cells and/or the serving cell). The candidate cells can be pre-defined or configured by RRC signaling. In some embodiments, the candidate cells or a subset of the candidate cells can be activated/deactivated/updated based on a signaling message (e.g., RRC, MAC CE, or DCI), measurement result(s), and/or corresponding event(s). The association between the configured measurement resources/configurations and the corresponding targets can be established by including target identification information (e.g., cell information and/or inter-frequency measurement information) at different levels of RRC Information Elements (IEs). Currently, the measurement information only distinguishes different TRPs under one cell without offering the flexibility of providing different measurement resources/configurations for cell selection and/or switching. Including the target identification information in one or more different levels enable flexible switching of reference signal measurements, thereby allowing faster changes of serving cell(s) without incurring significant signaling overhead.

In some embodiment, candidate target configuration is used to inform UE of the information of target that may be at least switched, measured, reporting, activated and updated.

For example, the target identification information can be included in at least one of the IEs: a reference signal (RS) configuration, a RS set configuration, a Transmission Configuration Indicator (TCI) state, an IE parameter that is related to the TCI state, a Control Resource Set (CORESET) pool, a CORESET, a CSI measurement configuration level (e.g., CSI-meas-config), a physical downlink control channel configuration (e.g., PDCCH-Config), a physical shared channel configuration (e.g., PDSCH-Config), a Bandwidth Part (BWP) configuration, a cell configuration (e.g., a serving cell configuration), or a cell group configuration.

In some embodiments, the inter-frequency measurement information can be included as part of the target identification information. The inter-frequency measurement information includes at least one of: time domain information, frequency domain information, the gap of measurement, whether to enable measurement gap, sub-carrier space (SCS), and/or BWP information. In some embodiments, the frequency domain information includes at least one of: the center frequency of bandwidth, frequency, the starting of frequency resource, the ending of frequency resource, the number of frequency resource, and/or bandwidth. The time domain information includes at least one of: measurement window configuration information, the starting of time resource, the ending of time resource, and/or the number of time resource.

In some embodiments, the measurement resources/configurations for candidate cells can be configured under the configuration of the current serving cell or outside the configuration of the current serving cell, or under the configuration of candidate cell different from the current serving cell. That is, measurement resources/configurations can be defined independently for candidate cell(s). An additional field, such as an identification field, can be introduced to identify the candidate cell.

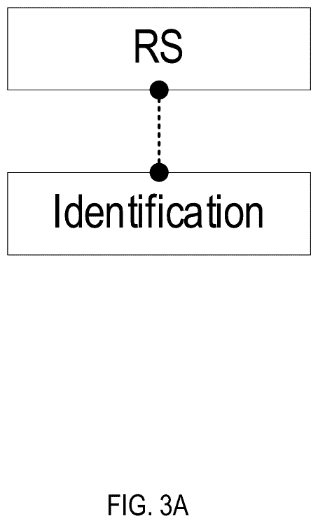

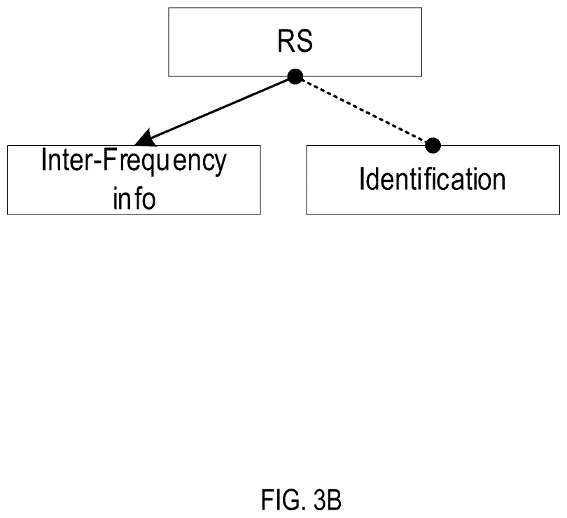

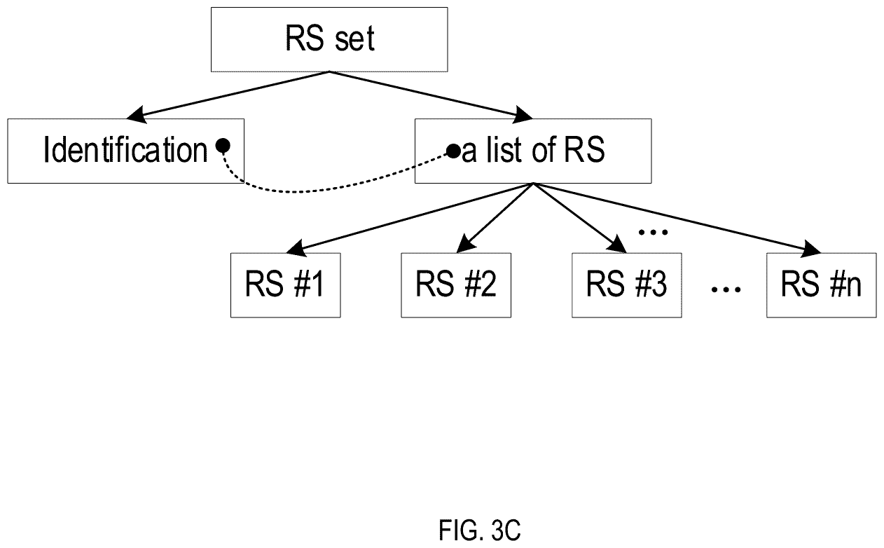

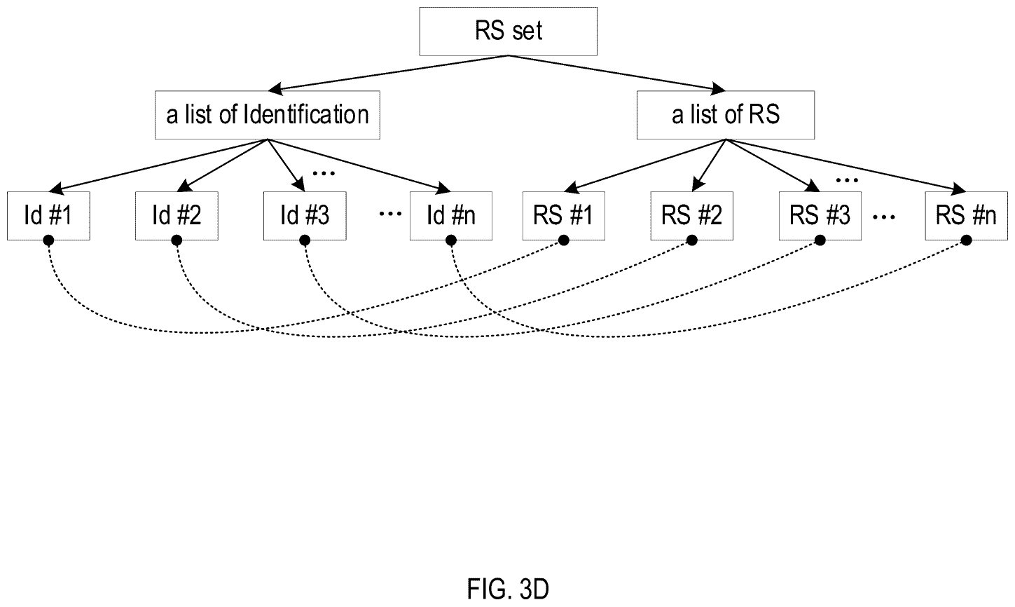

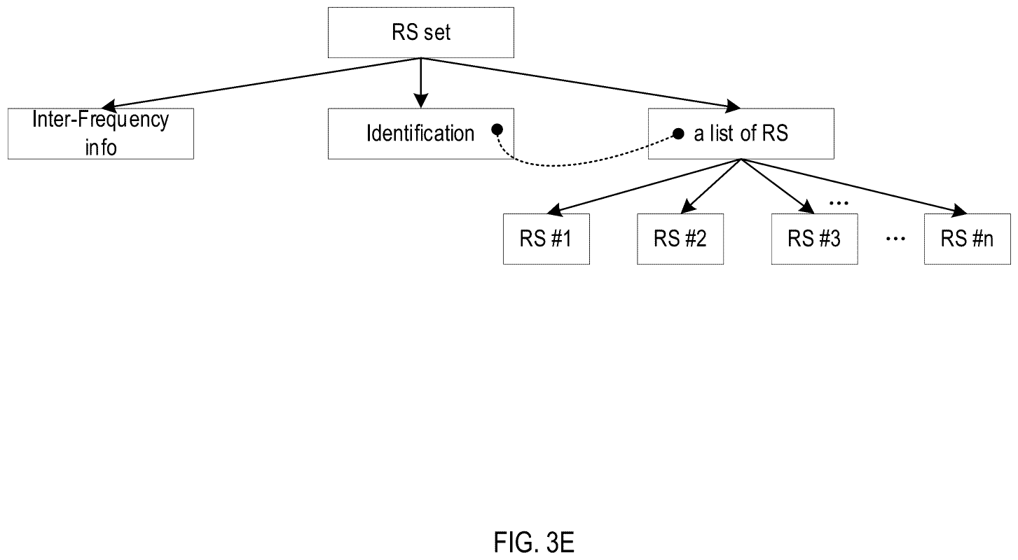

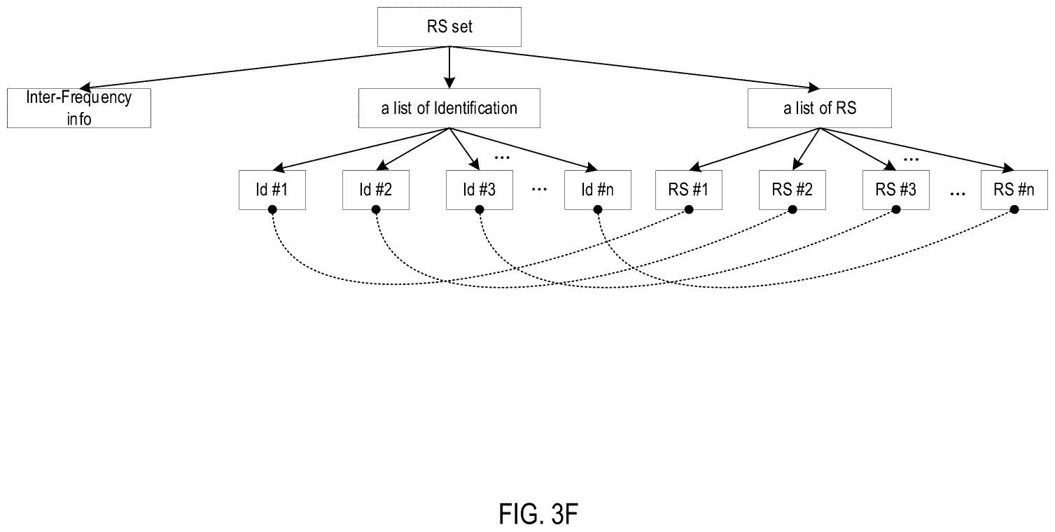

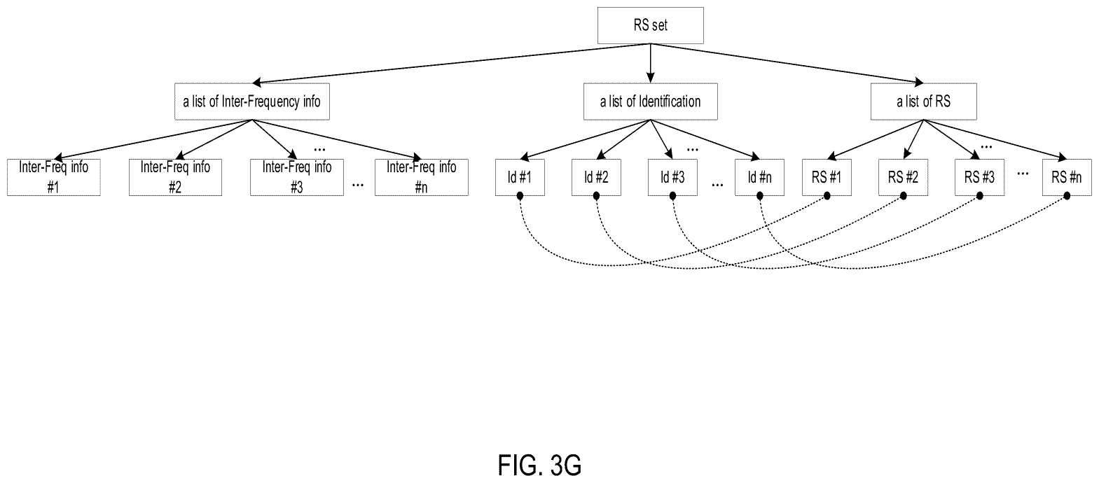

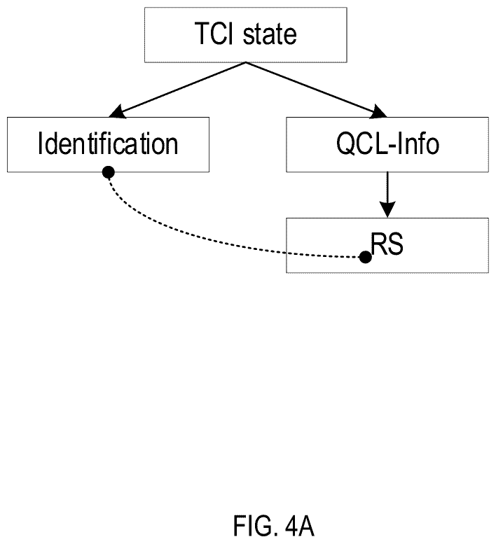

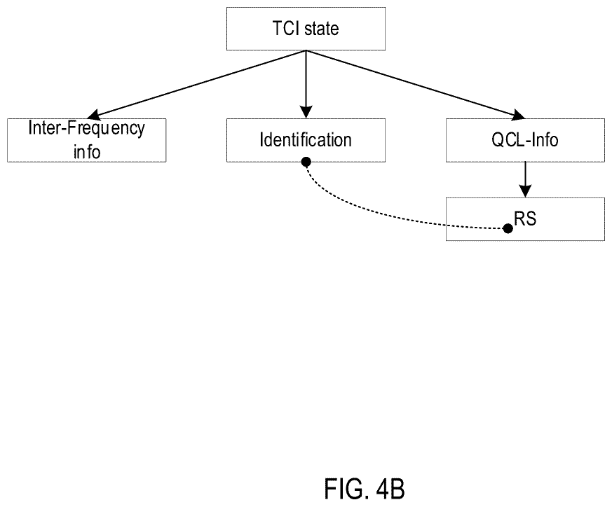

Specific examples of including the target identification information in different RRC IEs are further discussed in connection with FIG. 3A-FIG. 4B and Tables 1-7 below.

Case-1: Candidate cell(s) or identification(s) corresponding to candidate cell(s) can be included or provided in RS configuration.

In this case, the RS index or RS resource is associated with candidate cell or an identification corresponding to candidate cell, as shown in FIG. 3A. Different RS indexes or RS resources can be associated with same identification or different identifications.

In some embodiments, for inter-frequency measurement, inter-frequency measurement information can be provided in RS configuration, as shown in FIG. 3B.

Case-2: Candidate cell(s) or identification(s) corresponding to candidate cell(s) can be included or provided in RS set configuration.

In this case, the RS set (or a list of RS) or RS resource set (or a list of RS resource) is associated with candidate cell or an identification corresponding to candidate cell, as shown in FIG. 3C. Different RS or RS resource within a list of RS can be associated with the same identification.

In some embodiments, the RS within the RS set or the RS resource within the RS resource set is associated with candidate cell or an identification corresponding to candidate cell. Different RSs within the RS set or different RS resources within the RS resource set can be associated with different candidate cells or identifications corresponding to candidate cells, as shown in FIG. 3D.

In some embodiments, for inter-frequency measurement, inter-frequency information can be provided in RS set configuration, as shown in FIG. 3E. Inter-frequency information is configured for at least one candidate cell (or identification corresponding to candidate cell) and a list of RSs. In FIG. 3F, inter-frequency information is configured for at least candidate cells (or identifications corresponding to candidate cells) and a list of RSs. In FIG. 3G, a list of inter-frequency information is configured for at least candidate cells (or identifications corresponding to candidate cells) and a list of RSs.

Case-3: Candidate cell(s) or identification(s) corresponding to candidate cell(s) can be provided in the TCI state or a parameter that is related to the TCI state.

In some embodiments, RS index(s) or RS resource(s) in TCI state are associated with candidate cell(s) or identification(s) corresponding to candidate cell(s), as shown in FIG. 4A.

In some embodiments, RS index(s) or RS resource(s) are associated with candidate cell(s) or identification(s) corresponding to candidate cell(s). Alternatively, or in addition, at least one of candidate cell(s) or identification(s) corresponding to candidate cell(s) and inter-frequency information or inter-frequency information list are associated with TCI state(s), or at least one of one or more configurations in TCI state(s).

In some embodiments, for inter-frequency measurement, inter-frequency information can be provided in TCI state or a parameter that is related to TCI state, as shown in FIG. 4B.

Case-4: Candidate cell(s) or identification(s) corresponding to candidate cell(s) can be provided in CORESET Pool or controlResourceSet (CORESET).

In some embodiments, the RS or RS set is associated with candidate cell(s) or identification(s) corresponding to candidate cell(s) in CORESET Pool or controlResourceSet.

In some embodiments, a CORESET Pool index is associated with the candidate cell or identification corresponding to the candidate cell. For a list of candidate cells or identifications corresponding to the candidate cells, different CORESET Pool indexes can be associated with different identifications corresponding to candidate cell(s). In some embodiments, different CORESET Pool indexes can be associated with different TRPs, panels, ports, DUs, CUs, CCs, or BWPs.

In some embodiments, RS index(s) or RS resource(s) are associated with candidate cell(s) or identification(s) corresponding to candidate cell(s). Alternatively, or in addition, at least one of candidate cell(s) or identification(s) corresponding to the candidate cell(s) and inter-frequency information or inter-frequency information list are associated with at least one of TCI state, CORESET Pool(s), controlResourceSet(s), or at least one of one or more configurations in at least one of TCI state, CORESET Pool(s) or controlResourceSet(s).

In some embodiments, for inter-frequency measurement case, inter-frequency information can be provided in CORESET Pool configuration or controlResourceSet. Different inter-frequency information can be associated with different CORESET Pool indexes or controlResourceSets.

In some embodiments, for each CORESET Pool index, identification is associated with TCI state. Different identifications within a list of identification can be associated with different TCI states within a list of TCI states.

In some embodiments, for intra-frequency cases, the coresetPoolIndex shown as Option-1 in Table 1 can be extended to a list of indices including 1 to X values. In some embodiments, a new RRC parameters, such as coresetPoolIndex shown as Option-2 in Table 1 can be defined in ControlResourceSet. Here, X can be predefined, preconfigured, or configurable by at least one of RRC signaling, MAC CE signaling, DCI signaling. In some embodiments, the value of X can be equal to the number of cells, such as at least one of serving cell and/or candidate cell(s). In some embodiments, an identification such as Alt-1 shown in Table 1 or a list of identification such as Alt-2 shown in Table 1 can be included in ControlResourceSet. In some embodiments, for inter-frequency cases, inter-frequency information (e.g., Method-1 as shown in Table 1) or inter-frequency list (e.g., Method-2 as shown in Table 1) can be included in ControlResourceSet.

TABLE 1

| | |
|---|---|
| ControlResourceSet ::= | SEQUENCE { |
| controlResourceSetId | ControlResourceSetId, |

.....
Option-1: coresetPoolIndex-r16 INTEGER (0..X) OPTIONAL,
Option-2: coresetPoolIndex-rXX INTEGER (0..X) OPTIONAL,

| | |
|---|---|
| Alt-1: identification | Identification OPTIONAL, |
| Alt-2: identificationList | SEQUENCE (SIZE(1..maximum)) OF |
| | Indentificationindex OPTIONAL, |

Method-1: inter-frequency information
Method-2: inter-frequency information List
.....
}

Case-5: Candidate cell(s) or identification(s) corresponding to the candidate cell(s) can be provided in PDCCH-Config.

In some embodiments, a RS or RS set is associated with candidate cell(s) or identification(s) corresponding to candidate cell(s) in PDCCH-Config.

In some embodiments, PDCCH-Config is associated with a candidate cell or identification corresponding to the candidate cell. In some embodiments, ControlResourceSet within PDCCH-Config is associated with a candidate cell or identification corresponding to the candidate cell.

In some embodiments, RS index(s) or RS resource(s) can be associated with candidate cell(s) or identification(s) corresponding to the candidate cell(s). Alternatively, or in addition, at least one of candidate cell(s) or identification(s) corresponding to the candidate cell(s) and inter-frequency information or inter-frequency information list can be associated with at least one of TCI state(s), CORESET Pool(s), controlResourceSet(s), PDCCH-Config(s), or at least one of one or more configurations in at least one of TCI state(s), CORESET Pool(s), controlResourceSet(s), or PDCCH-Config(s).

In some embodiments, for inter-frequency cases, inter-frequency information can be included in PDCCH-Config. In some embodiments, for intra-frequency cases, an identification, such as Alt-1 shown in Table 2, or a list of identifications, such as Alt-2 shown in Table 2 can be included in PDCCH-Config. In some embodiments, for inter-frequency cases, inter-frequency information (e.g., Method-1 as shown in Table 2) or inter-frequency list (e.g., Method-2 as shown in Table 2) can be included in PDCCH-Config.

TABLE 2

| | |
|---|---|
| PDCCH-Config ::= | SEQUENCE { |

controlResourceSetToAddModList SEQUENCE(SIZE (1..3)) OF

| | |
|---|---|
| ControlResourceSet | OPTIONAL, -- Need N |

controlResourceSetToReleaseList SEQUENCE(SIZE (1..3)) OF

| | |
|---|---|
| ControlResourceSetId | OPTIONAL, -- Need N |
| Alt-1: identification | Identification OPTIONAL, |
| Alt-2: identificationList | SEQUENCE (SIZE(1..maximum)) OF |

Indentificationindex OPTIONAL,
Method-1: inter-frequency information
Method-2: inter-frequency information List
......
}

Case-6: Candidate cell(s) or identification(s) corresponding to the candidate cell(s) can be included or provided in CSI-MeasConfig.

In some embodiments, a RS or RS set is associated with candidate cell(s) or identification(s) corresponding to the candidate cell(s) in CSI-MeasConfig.

In some embodiments, different candidate cells or identifications corresponding to candidate cells within a list of candidate cell or identifications corresponding to the candidate cells are associated with different CSI-MeasConfigs.

In some embodiments, RS index(s) or RS resource(s) can be associated with candidate cell(s) or identification(s) corresponding to the candidate cell(s). Alternatively, or in addition, at least one of candidate cell(s) or identification(s) corresponding to the candidate cell(s) and inter-frequency information or inter-frequency information list are associated with at least one of TCI state(s), CORESET Pool(s), controlResourceSet(s), PDCCH-Config(s), CSI-MeasConfig(s), or at least one of one or more configurations in at least one of TCI state(s), CORESET Pool(s), controlResourceSet(s), PDCCH-Config(s), or CSI-MeasConfig(s).

In some embodiments, for inter-frequency measurement cases, inter-frequency information can be provided in CSI-MeasConfig, Different inter-frequency information can be associated with different CSI-MeasConfigs. In some embodiments, TCI state or a list of TCI state can be included in CSI-MeasConfig. Different TCI states or different TCI state lists can be associated with different identifications or the same identification.

In some embodiments, for intra-frequency cases, an identification, such as Alt-1 shown in Table 3, or a list of identification, such as Alt-2 shown in Table 3, can be included in CSI-MeasConfig. In some embodiments, for inter-frequency cases, inter-frequency information (e.g., Method-1 as shown in Table 3) or an inter-frequency list (e.g., Method-2 as shown in Table 3) can be included in CSI-MeasConfig. In some embodiments, similar information can be included in ServingCellConfig and/or CellGroupConfig.

TABLE 3

| | |
|---|---|
| CSI-MeasConfig ::= | SEQUENCE { |

nzp-CSI-RS-ResourceToAddModList SEQUENCE (SIZE (1..maxNrofNZP-
CSI-RS-Resources)) OF NZP-CSI-RS-Resource OPTIONAL, -- Need N
nzp-CSI-RS-ResourceToReleaseList SEQUENCE (SIZE (1..maxNrofNZP-
CSI-RS-Resources)) OF NZP-CSI-RS-ResourceId OPTIONAL, -- Need N
.....

| | |
|---|---|
| Alt-1: identification | Identification OPTIONAL, |
| Alt-2: identificationList | SEQUENCE (SIZE(1..maximum)) OF |

Indentificationindex OPTIONAL,
Method-1: inter-frequency information
Method-2: inter-frequency information List
......
}

Case-7: Candidate cell(s) or identification(s) corresponding to the candidate cell(s) can be provided in PDSCH-Config.

In some embodiments, a RS or RS set is associated with candidate cell(s) or identification(s) corresponding to the candidate cell(s) in PDSCH-Config.

In some embodiments, different RSs, RS sets, TCI states, or TCI state lists can be associated with the same candidate cell or the same identification corresponding to the candidate cell, or different candidate cells or identifications corresponding to the candidate cells. Different candidate cells or identifications corresponding to the candidate cells can be associated with different PDSCH-Configs.

In some embodiments, RS index(s) or RS resource(s) can be associated with candidate cell(s) or identification(s) corresponding to the candidate cell(s). Alternatively, or in addition, at least one of candidate cell(s) or identification(s) corresponding to the candidate cell(s) and inter-frequency information or inter-frequency information list can be associated with at least one of TCI state(s), CORESET Pool(s), controlResourceSet(s), PDCCH-Config(s), PDSCH-Config(s), or at least one of one or more configurations in at least one of TCI state, CORESET Pool(s), controlResourceSet(s), PDCCH-Config(s), or PDSCH-Config(s).

In some embodiments, for intra-frequency cases, an identification, such as Alt-1 shown in Table 3, or a list of identifications, such as Alt-2 shown in Table 4, can be included in PDSCH-Config. In some embodiments, for inter-frequency cases, inter-frequency information (e.g., Method-1 in Table 4) or an inter-frequency list (e.g., Method-2 in Table 4) can be included in PDSCH-Config.

TABLE 4

| | |
|---|---|
| PDSCH-Config ::= | SEQUENCE { |

```
  controlResourceSetToAddModList SEQUENCE(SIZE (1..N)) OF ControlResourceSet
OPTIONAL, -- Need N
    controlResourceSetToReleaseList SEQUENCE(SIZE (1..N)) OF ControlResourceSetId
OPTIONAL, -- Need N
```

| | |
|---|---|
| Alt-1: identification | Identification OPTIONAL, |
| Alt-2: identificationList | SEQUENCE (SIZE(1..maximum)) OF Indentificationindex |

```
OPTIONAL,
    Method 1: inter-frequency information
    Method 2: inter-frequency information List
  ......
}
```

Case-8: Candidate cell(s) or identification(s) corresponding to candidate cell(s) can be provided in BWP configuration.

In some embodiments, a RS or RS set is associated with candidate cell(s) or identification(s) corresponding to the candidate cell(s) in BWP configuration.

In some embodiments, RS index(s) or RS resource(s) can be associated with candidate cell(s) or identification(s) corresponding to the candidate cell(s); In some embodiments, at least one of candidate cell(s) or identification(s) corresponding to the candidate cell(s) and inter-frequency information or inter-frequency information list can be associated with at least one of TCI state(s), CORESET Pool(s), controlResourceSet(s), PDCCH-Config(s), PDSCH-Config(s), BWP configuration(s), or at least one of one or more configurations in at least one of TCI state, CORESET Pool(s), controlResourceSet(s), PDCCH-Config(s), PDSCH-Config(s), or BWP configuration(s).

In some embodiments, for inter-frequency cases, inter-frequency information or inter-frequency information list can be included in BWP configuration. Table 5 shows an example information element for a BWP-DownlinkDedicated IE in accordance with one or more embodiments of the present technology. A first list of CORESET pools to be added and a second list of CORESET pools to be released can be included in the BWP-DownlinkDedicated IE. In some embodiments, shown as Alt-1 in Table 5, a parameter Identification can be included. In some embodiments, shown as Alt-2 in Table 5, a list of identifications can be included. In some embodiments, inter-frequency information or a list of inter-frequency information can be included.

TABLE 5

| | |
|---|---|
| BWP-DownlinkDedicated ::= | SEQUENCE { |
| controlResourceSetToAddModList | SEQUENCE(SIZE (1..N)) OF |

ControlResourceSet OPTIONAL, -- Need N

| | |
|---|---|
| controlResourceSetToReleaseList | SEQUENCE(SIZE (1..N)) OF |

ControlResourceSetId OPTIONAL, -- Need N
.....

| | |
|---|---|
| Alt-1: identification | Identification OPTIONAL, |
| Alt-2: identificationList | SEQUENCE (SIZE(1..maximum)) |

```
OF Indentificationindex OPTIONAL,
    inter-frequency information/inter-frequency information List
  ......
```

| | |
|---|---|
| Alt-1: identification | Identification OPTIONAL, |
| Alt-2: identificationList | SEQUENCE (SIZE(1..maximum)) |

OF Indentificationindex OPTIONAL,
inter-frequency information/inter-frequency information List
}

Case-9: Candidate cell(s) or identification(s) corresponding to the candidate cell(s) can be included or provided in ServingCellConfig.

In some embodiments, a RS or RS set is associated with candidate cell(s) or identification(s) corresponding to the candidate cell(s) in ServingCellConfig.

In some embodiments, RS index(s) or RS resource(s) can be associated with candidate cell(s) or identification(s) corresponding to candidate cell(s). Alternatively, or in addition, at least one of candidate cell(s) or identification(s) corresponding to the candidate cell(s) and inter-frequency information or inter-frequency information list can be associated with at least one of TCI state(s), CORESET Pool(s), controlResourceSet(s), PDCCH-Config(s), PDSCH-Config(s), BWP configuration(s), servingCellConfig(s), or at least one of one or more configurations in at least one of TCI state, CORESET Pool(s), controlResourceSet(s), PDCCH-Config(s), PDSCH-Config(s), BWP configuration(s), or servingCellConfig(s).

In some embodiments, for inter-frequency cases, inter-frequency information or inter-frequency information list can be included in ServingCellConfig.

Table 6 shows an example information element for a ServingCellConfig IE in accordance with one or more embodiments of the present technology. A first list of CORESET pools to be added and a second list of CORESET pools to be released can be included in the ServingCellConfig IE. In some embodiments, shown as Alt-1 in Table 6, a parameter Identification can be included. In some embodiments, shown as Alt-2 in Table 6, a list of identifications can be included. In some embodiments, inter-frequency information or a list of inter-frequency information can be included.

TABLE 6

| | |
|---|---|
| ServingCellConfig ::= | SEQUENCE { |

```
  controlResourceSetToAddModList SEQUENCE(SIZE (1..N)) OF
ControlResourceSet OPTIONAL, -- Need N
    controlResourceSetToReleaseList SEQUENCE(SIZE (1..N)) OF
ControlResourceSetId OPTIONAL, -- Need N
  .....
```

| | |
|---|---|
| Alt-1: identification | Identification OPTIONAL, |
| Alt-2: identificationList | SEQUENCE (SIZE(1..maximum)) |

```
OF Indentificationindex OPTIONAL,
    inter-frequency information/inter-frequency information List
  ......
}
```

Case-10: Candidate cell(s) or identification(s) corresponding to the candidate cell(s) can be provided in the cell configuration or the cell group configuration.

In some embodiments, a RS or RS set is associated with candidate cell(s) or identification(s) corresponding to the candidate cell(s) in the cell configuration or the cell group configuration.

In some embodiments, RS index(s) or RS resource(s) can be associated with candidate cell(s) or identification(s) corresponding to the candidate cell(s). Alternatively, or in addition, at least one of candidate cell(s) or identification(s) corresponding to the candidate cell(s) and inter-frequency information or inter-frequency information list can be associated with at least one of TCI state(s), CORESET Pool(s), controlResourceSet(s), PDCCH-Config(s), PDSCH-Config(s), BWP configuration(s), servingCellConfig(s), cell configuration(s) or cell group configuration(s), or at least one of one or more configurations in at least one of TCI state, CORESET Pool(s), controlResourceSet(s), PDCCH-Config(s), PDSCH-Config(s), BWP configuration(s), servingCellConfig(s), cell configuration(s) or cell group configuration(s).

In some embodiments, for inter-frequency measurement cases, inter-frequency information or a list of inter-frequency information can be provided in cell configuration or cell group configuration.

Table 7 shows an example information element for a CellGroupConfig IE in accordance with one or more embodiments of the present technology. In some embodiments, shown as Alt-1 in Table 7, a parameter Identification can be included in CellGroupConfig. In some embodiments, shown as Alt-2 in Table 7, a list of identifications can be included in CellGroupConfig. In some embodiments, inter-frequency information or a list of inter-frequency information can be included in CellGroupConfig. In some embodiments, similar information can be included in BWP and/or ServingCellConfig(or ServingCellConfig related RRC parameter) and/or CellGroupConfig.

TABLE 7

| | |
|---|---|
| CellGroupConfig ::= | SEQUENCE { |
| cellGroupId | CellGroupId, |
| rlc-BearerToAddModList | SEQUENCE (SIZE(1..maxLC-ID)) OF RLC- |

| | |
|---|---|
| BearerConfig | OPTIONAL, -- Need N |

| | |
|---|---|
| rlc-BearerToReleaseList | SEQUENCE (SIZE(1..maxLC-ID)) OF |

| | |
|---|---|
| LogicalChannelIdentity | OPTIONAL, -- Need N |
| mac-CellGroupConfig | MAC-CellGroupConfig |

OPTIONAL, -- Need M
.....

| | |
|---|---|
| Alt-1: identification | Identification OPTIONAL, |
| Alt-2: identificationList | SEQUENCE (SIZE(1..maximum)) OF Indentificationindex |

OPTIONAL,
inter-frequency information/inter-frequency information Lis

In some embodiments, one or more of combinations of the above cases can be applied for embodiments of the disclosed techniques.

In some embodiments, inter-frequency information can be included in at least one of the RS configuration, the RS set configuration, the TCI state, a parameter that is related to the TCI state, the CORESET Pool, the controlResourceSet, the PDCCH-Config, the CSI-meas-config, the PDSCH-Config, the BWP configuration, the ServingCellConfig, the cell configuration, the cell group configuration.

In some embodiments, inter-frequency information includes at least one of: time domain information, frequency domain information, the gap of measurement, whether to enable measurement gap, sub-carrier space (SCS), Bandwidth part (BWP) information.Frequency domain information can include at least one of the center frequency of bandwidth, frequency, the starting of frequency resource, the ending of frequency resource, the number of frequency resource, bandwidth and so on. Time domain information includes at least one of measurement window configuration information, the starting of time resource, the ending of time resource, the number of time resource, length, measurement gap, SS/PBCH block measurement timing configuration (SMTC), and so on.

In some embodiment, at least one of RS or RS set configuration, TCI state configuration, controlResourceSet configuration, PDCCH-Config configuration, PDSCH-Config configuration, BWP configuration, CSI-MeasConfig configuration, inter-frequency information, reporting configuration can be configured in candidate target(s) configuration.

In some embodiment, RS(s) configuration or RS set(s) configuration for candidate cell(s) or identification(s) corresponding to candidate cell(s) can be inferred based on one or more QCL and/or TCI state relationship between RS(s) configurations, RS set(s) for measurement or reporting, and/or RS(s) configuration or RS set(s) configuration for candidate cell(s) or identification corresponding to the candidate cell(s).

In some embodiments, measurement resource(s) or configuration can be determined based on at least one of: RRC signaling configuration, pre-configured, pre-defined, reporting configuration, and/or candidate cell configuration.

In some embodiments, for reporting, at least one of the following several methods can be considered:

Method 1: Reporting can be performed based on the legacy CSI report framework. A reporting configuration can be associated with a measurement configuration,

Method 2: Reporting is performed based on measurement results. Reporting resource(s) or reporting configuration(s) can be determined based on measurement resource(s) or measurement configuration(s). Alternatively, or in addition, measurement resource(s) or measurement configuration(s) can be determined based on reporting resource(s) or reporting configuration(s). In some embodiments, there exists an association between measurement resource(s) or measurement configuration(s) and reporting resource(s) or reporting configuration(s). In some embodiments, the association can be predefined/preconfigured or determined by at least one of RRC signaling, MAC CE signaling, or DCI signaling.

In some embodiments, reporting can be triggered by events. In some embodiments, for event-driven reporting, if the event has occurred, then reporting can be performed by UE.

In some embodiments, reporting is indicated or triggered by a signaling message.

In some embodiments, at least one of the following associations or any combination thereof can be considered: a RS is associated with an identification corresponding to a candidate cell; a RS is associated with a list of identifications corresponding to candidate cells; a RS set is associated with an identification corresponding to a candidate cell; a RS set is associated with a list of identifications corresponding to candidate cells; a RS is associated with inter-frequency information; a RS set is associated with inter-frequency information; a RS is associated with frequency information; a RS set is associated with frequency information; a RS is associated with a measurement gap; a RS set is associated with a measurement gap; a RS is associated with the Synchronization Signal (SS)/Physical Broadcast Channel (PBCH) block measurement timing configuration (SMTC); a RS set is associated with the SS/PBCH block measurement timing configuration (SMTC); a RS is associated with the reporting configuration; a RS set is associated with the reporting configuration. The associations can be predefined/preconfigured or determined by at least one of RRC signaling, MAC CE signaling, or DCI signaling.

In some embodiments, at least one of one or more measurement resources or configurations, candidate cells, the reporting configuration, the TCI state, the Timing Advance (TA), the Random Access Channel (RACH) resource configuration, the Downlink (DL) and/or Uplink (UL) resource configuration can be activated or deactivated or updated. In some embodiments, the activation or deactivation or update is based on at least one of a signaling message, measurement results (e.g., previous measurement results or current measurement results), some historic records, actual implementations, UE capability, measurement results of the serving cell, and/or events. The signaling message can be at least one of RRC, MAC CE and/or DCI.

In some embodiments, activated or deactivated or updated information(s) can also activate or deactivate or update at least one of one or more measurement resources or configurations, candidate cells, related configuration information on one or more candidate cells, the reporting configuration, the TCI state, the TA, the RACH related configuration, the DL and/or UL resource configuration, at least one parameter configuration included in configuration that includes (or associated with) activated or deactivated or updated information(s). At least one of the following can be considered, but other combination schemes are also applicable:

1. If one or more reference signal configurations are activated, deactivated, or updated, one or more reporting configurations for RS configuration can be activated, deactivated, or updated,

2. If one or more reference signal configurations are activated, deactivated, or updated, one or more candidate cells for RS configuration and/or related configuration information on one or more candidate cells can be activated, deactivated, or updated.

3. If one or more candidate cells are activated, deactivated, or updated, one or more reference signal configurations for candidate cell and/or related configuration information on one or more candidate cells can be activated, deactivated, or updated.

4. If one or more candidate cells are activated, deactivated, or updated, one or more reporting configurations for candidate cell and/or related configuration information on one or more candidate cells can be activated, deactivated, or updated.

5. If one or more reporting configurations are activated, deactivated, or updated, one or more reference signal configurations for reporting can be activated, deactivated, or updated.

6. If one or more reporting configurations are activated, deactivated, or updated, one or more candidate targets for reporting and/or related configuration information on one or more candidate cells can be activated, deactivated, or updated.

7. If one or more reference signal configurations are activated, deactivated, or updated, one or more TCI states for RS configuration can be activated, deactivated, or updated.

8. If one or more candidate targets are activated, deactivated, or updated, one or more TCI states for TCI state and/or related configuration information on one or more candidate cells can be activated, deactivated, or updated.

9. If one or more reporting configurations are activated, deactivated, or updated, one or more TCI state for reporting can be activated, deactivated, or updated.

10. If one or more reference signal configurations are activated, deactivated or updated, at least one of one or more TA values, RACH related configurations, DL and/or UL resource configurations for RS configurations can be activated, deactivated, or updated.

11. If one or more candidate cells is activated, deactivated, or updated, at least one of one or more TA values, RACH related configurations, and/or DL and/or UL resource configurations for candidate cells can be activated, deactivated, or updated.

12. If one or more reporting configurations are activated, deactivated, or updated, at least one of one or more TA values, RACH related configurations, and/or DL and/or UL resource configurations for reporting can be activated, deactivated, or updated.

In some embodiments, whether to active, deactivate, or update the above parameters/configurations (e.g., one or more measurement resources or configurations for one or more candidate cells, one or more candidate cells, one or more reporting configurations for one or more candidate cells, TCI states of one or more candidate cells, TA values for one or more candidate cells, RACH related configurations for one or more candidate cells and/or DL and/or UL resource configurations for one or more candidate cells) depends on measurement results from the serving cell and/or candidate cell(s). In some embodiments, if the measurement result from serving cell and/or candidate cell(s) satisfies a specific condition or exceeds a threshold, then UE can report the measurement results to network or base station. Alternatively, or in addition, the activation, deactivation, or update of the above parameters/configurations can be determined and indicated by base station using at least one of MAC CE signaling, DCI signaling, or RRC signaling. The UE can also determine the activation, deactivation, or update of the above parameters/configures based on events. In some embodiments, if the measurement results from serving cell satisfies a specific condition or exceeds a threshold, then a list of measurement resource or configuration for one or more candidate cells, one or more candidate cells, one or more reporting configurations for one or more candidate cells, the TCI state for one or more candidate cells, TA values for one or more candidate cells, RACH related configurations for one or more candidate cells and/or DL and/or UL resource configuration for one or more candidate cells can be activated or deactivated upon an occurrence of an event or upon a specific condition or threshold being satisfied.

In some embodiments, if the number of times a condition is continuously or discontinuously satisfied reaches a threshold, at least one of a measurement, a measurement configuration, and/or reporting for candidate cell is activated or deactivated.

In some embodiments, the number of measurements, measurement configurations or reporting for a candidate target is fixed, configurable, or based on UE capability.

In some embodiments, the condition or event can be at least one of the following:

(1) One or more Reference Signal Received Power (RSRP) values measured from a RS set associated with serving target is equal to or greater than a first threshold.

(2) One or more RSRP values measured from a RS set associated with serving target is equal to or greater than the first threshold with an offset.

(3) One or more RSRP values measured from a RS set associated with serving target is equal to or greater than the first threshold but smaller than a second threshold.

(4) One or more RSRP values measured from a RS set associated with serving target is equal to or greater than the first threshold and is also equal to or greater than the second threshold.

In some embodiments, one or more measurement resources or configurations can be directly used by the UE to measure at least one of one or more candidate cells and serving cell based on the association between the measurement resources or configurations and candidate cells.

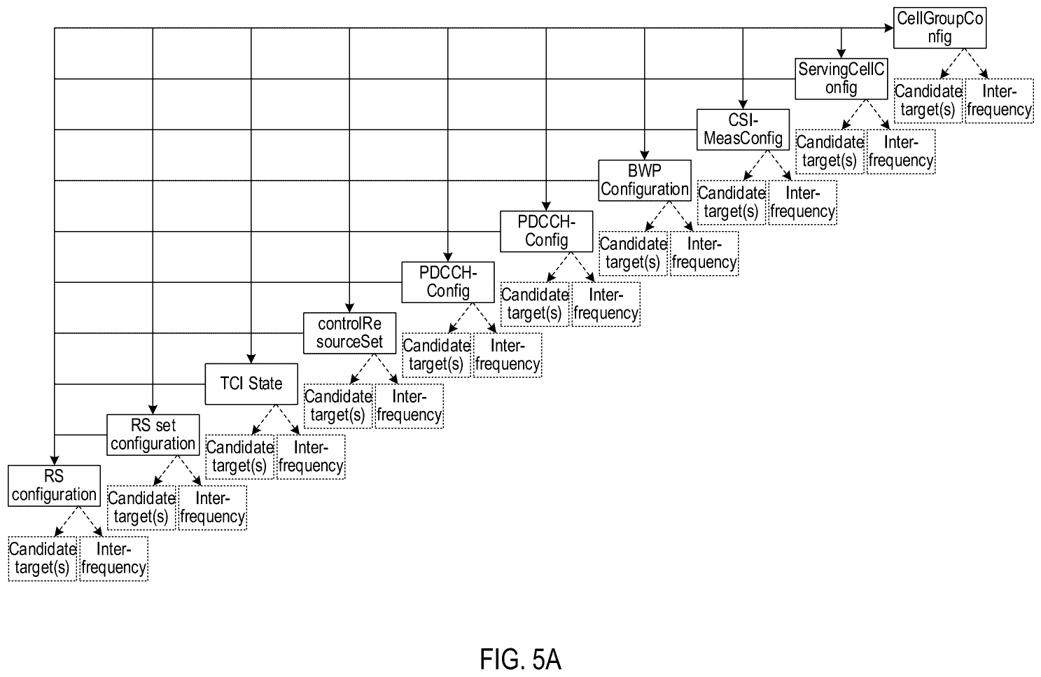

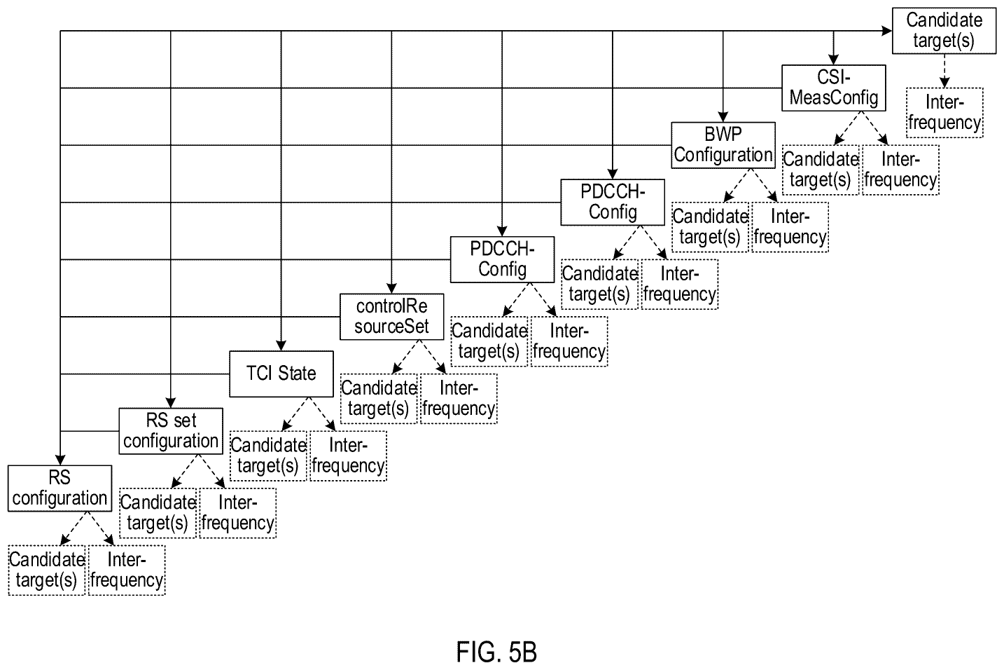

In some embodiments, one or more candidate cells can be configured under the configuration of the current serving cell and/or outside the configuration of the current serving cell, cell group configuration and/or other cell-level configurations. In some embodiments, measurement resources or measurement configurations for one or more candidate cells can be configured under the configuration of the current serving cell and/or outside the configuration of the current serving cell, or under the configuration of a candidate cell different from the current serving cell. Measurement resources or measurement configurations can be determined independently for one or more candidate cells. FIGS. 5A-5B further illustrate the flexibility of providing different measurement resources/configurations for cell selection and/or switching by including the target identification information in one or more different levels. The hierarchical order and/or relationship between different RRC configurations can be fixed or dynamically adjusted/configured. For example, in each RRC configuration, at least one of a candidate cell, a list of candidate cells and/or inter-frequency can be configurable.

In some embodiments, one or more candidate cells are associated with one or more related configurations of the candidate cell. Here, the related configuration of candidate cell can be at least one of physical layer configuration, MAC configuration, RLC configuration, RRC configuration, measurement resource configuration, RACH related configuration, reporting resource configuration, common channel/signal configuration, dedicated channel/signal configuration and so on.

### Embodiment 2

Currently, the reporting of the measurement can be triggered by events that occur at a high layer (e.g., L3). For example, several types of events (e.g., Event A1-A5, CondEvent A3, etc.) are defined at the RRC level in the report configuration. However, triggering these events may take a long time as the lower layers need to consolidate information and inform L3 of the measurements. To enable more prompt reporting for beam switch, cell change and/or reference signal measurements, it is desirable to introduce event-based reporting at lower layers. In some embodiments, a L1/L2 timer that is shorter than the L3 timer can be introduced. The time-domain unit of this timer can be a symbol, a slot, a subframe, a frame, a nanosecond, a microsecond, or a millisecond, second. The duration of timer can be predefined, indicated by the network (e.g., via RRC, MAC CE, and/or DCI signaling), and/or determined by any combination of at least one of one or more of these units to provide shorter response time as compared to the L3 counterpart, thereby enabling faster cell switching for UE mobility.

In some embodiments, the reporting of the measurement results can be initiated based on an event-driven beam reporting scheme according to a set of conditions. Some example conditions are described as follows.

Condition-1A: When the UE detects that an event has occurred, the UE immediately triggers reporting.

Condition-2A: A first timer is introduced to terminate UE reporting. Before the first timer expires, even when the UE detects that one or more events have occurred, the UE does not report measurement results. Once the first timer expires, UE triggers reporting.

Condition-3A: A second timer is introduced to initiate UE reporting. When the UE detects that an event has occurred, the second timer is started/restarted. If the number of times the event has occurred is greater than or equal to a threshold before the second timer expires, the UE triggers reporting. The event can occur consecutively or non-consecutively.

Condition-4A: The second timer is introduced to initiate UE reporting. When the UE detects that an event has occurred, the second timer is started/restarted. If the number of times the event has occurred is greater than or equal to a first threshold and less than or equal to a second threshold before the second timer expires, the UE triggers reporting. The event can occur consecutively or non-consecutively.

Condition-5A: When the UE detects that an event has occurred and the number of times the event has occurred is greater than or equal to a threshold, the UE triggers reporting. The event can occur consecutively or non-consecutively.

Condition-6A: When the UE detects that an event has occurred, and when the number of times the event has occurred is greater than or equal to a first threshold and less than or equal to a second threshold, the UE triggers reporting. The event can occur consecutively or non-consecutively.

Condition-7A: When the number of events that have occurred is less than (or greater than) a threshold (e.g., the maximum number of events that is allowed to occur), the UE triggers reporting. The events can occur consecutively or non-consecutively.

In some embodiments, the reporting of the measurement results can be terminated based on the event-drive beam reporting scheme according to a set of conditions. Some example conditions are described as follows.

Condition-1B: Once a reporting is transmitted, the UE stops reporting.

Condition-2B: When the number of reporting is greater than or equal to a threshold, the UE stops reporting. Reporting can be performed consecutively or non-consecutively.

Condition-3B: When the number of reporting is greater than or equal to a first threshold and is also greater than or equal to a second threshold, the UE stops reporting. Alternatively, or in addition, when the number of reporting is greater than or equal to the first threshold and less than or equal to the second threshold, the UE stops reporting. In some embodiments, the first threshold is less than or equal to the second threshold.

Condition-4B: When a first timer that is used to terminate UE reporting is started/restarted, the UE stops reporting.

Condition-5B: When a second timer that is used to initiate UE reporting expires, the UE stops reporting on the (available) resource(s).

Condition-6B: When the number of reporting is less than or equal to a threshold before the first or the second timer expires, UE stops reporting. In some embodiments, when the number of reporting is greater than or equal to a threshold before the first or the second timer expires, UE stops reporting. In some embodiments, the threshold here in the same as the threshold in Condition 3A.

Condition-7B: When the number of reporting is greater than or equal to a threshold (e.g., the maximum number of reporting or the maximum number of occurrences for an event) and before a timer expires, the UE stops reporting; In some embodiments, the threshold here is greater than or equal to the second threshold in Condition 4A.

Condition-8B: When the number of reporting is greater than or equal to a threshold before a timer expires, the UE stops reporting. Here, the timer can be introduced to count the number of reporting before the timer expires.

Condition-9B: When the UE receives an indicator from gNB, UE stops reporting. The indicator can be provided by at least one of DCI, MAC CE, and/or RRC.

Condition-10B: When the number of reporting is greater than or equal to a first threshold and less than or equal to a second threshold after a first timer that is used to terminate UE reporting expires, UE stops reporting.

Condition-11B: When the number of reporting is greater than or equal to a threshold before a second timer that is used to initiate UE reporting expires, UE stops reporting.

Condition-12B: When the number of reporting is greater than or equal to a first threshold and less than or equal to a second threshold before a second timer that is used to initiate UE reporting expires, UE stops reporting.

Condition-13B: When the number of reporting is greater than or equal to the maximum number of reporting that is allowed, UE stops reporting.

In the above examples, the available configured resource(s) for reporting include the most recent resource(s) after the event occurs. In some embodiments, the available resource(s) can be determined based on an offset and/or the number of consecutive or non-consecutive resources configured for the reporting (e.g., resources associated with the number of reporting). The offset and/or the number of resources can be provided by at least one of RRC, MAC CE and/or DCI singling. Alternatively, or in addition, the offset is based on the starting position of the slot in which the event has occurred and/or the end position of the slot in which the event has occurred.

In some embodiments, the available resource(s) correspond to a reporting configuration that is associated with one or more measurement resources/configurations. In some embodiments, the time-domain behavior of the reporting can be periodic, semi-persistent, aperiodic, or UE-initiated.

In some embodiments, at least one of the reporting parameters is preconfigured/predefined or be signaled by the base station via RRC, MAC CE, and/or DCI. The at least one reporting parameter can be the number of reporting, the period of reporting, whether the timer is enabled or disabled, the period of the timer, the duration of the timer, the number of resources or resource sets for reporting, the offset for determining reporting resource(s)/resource set(s), one or more thresholds, the number of times that an event needs to occur to trigger reporting, etc. The offset for determining reporting resource(s)/resource set can be determined by the starting or ending position of the measurement resource(s) or the slot/subframe in which the signaling that configures measurement/reporting is received.

### Embodiment 3

In some embodiments, the event-driven beam reporting scheme can include a set of L1/L2 layer events. Some example events are described as follows.

Event-1: This event occurs when a number of RSRP values (denoted as P1 values) corresponding to the reference signals within a first RS set (denoted as Yi) associated with one or more identifications corresponding to candidate cells that is different from the serving cell is greater than or equal to a RSRP value measured for a specified RS in a second RS set (denoted as X) that is associated with the serving cell. Here, the minimum value of P1 can be 1, and the maximum value of P1 can be the number of reference signals in the Yi RS set, where i represents a cell different from the serving cell and the value of i is based on the number of candidate cells.

Event-2: This event occurs when a number of RSRP values (denoted as P1 values) corresponding to the reference signals within a first RS set (denoted as Yi) associated with one or more identifications corresponding to candidate cells that is different from the serving cell is greater than or equal to a number of RSRP values (denoted as P2 values) measured for a second RS set (denoted as X) that is associated with the serving cell. Here, P2 can be an integer greater than or equal to 1. The maximum value of P2 can be the number of references signals in the second RS set. The minimum value of P1 can be 1, and the maximum value of P1 can be the number of reference signals in the Yi set, where i represents a cell different from the serving cell and the value of i is based on the number of candidate cells. In some embodiments, at least one of P1 RSRP values is greater than one of (1) the best all P2 RSRP values, (2) each of the P2 RSRP values, or (3) some of P2 RSRP values.

Event-3: This event occurs when a number of RSRP values (denoted as P1 values) corresponding to the reference signals within a first RS set (denoted as Yi) associated with one or more identifications corresponding to candidate cells that is different from the serving cell is greater than or equal to a RSRP value measured for a specified RS in a second RS set (denoted as X) that is associated with the serving cell and an offset value. Here, the minimum value of P1 can be 1, and the maximum value of P1 can be the number of reference signals in the Yi set, where i represents a cell different from the serving cell and the value of i is based on the number of candidate cells. The offset value can be pre-defined/preconfigured or be indicated by at least one of RRC, MAC CE, and/or DCI.

Event-4: This event occurs when a number of RSRP values (denoted as P1 values) corresponding to the reference signals within a first RS set (denoted as Yi) associated with one or more identifications corresponding to candidate cells that is different from the serving cell is greater than or equal to a number of RSRP values (denoted as P2 values) measured for a second RS set (denoted as X) that is associated with the serving cell and an offset value. Here, P2 can be an integer greater than or equal to 1. The maximum value of P2 can be the number of references signals in the set. The minimum value of P1 can be 1, and the maximum value of P1 can be the number of reference signals in the Yi set, where i represents a cell different from the serving cell and the value of i is based on the number of candidate cells. The offset value can be pre-defined/preconfigured or be indicated by at least one of RRC, MAC CE, and/or DCI.

Event-5: This event occurs when the RSRP value measured for a specified RS in a RS set (denoted as X) that is associated with the serving cell is smaller than or equal to a first threshold, and/or a number of RSRP values (denoted as P1 values) corresponding to the reference signals within a first RS set (denoted as Yi) associated with one or more identifications corresponding to candidate cells that is different from the serving cell is greater than or equal to a second threshold. The first threshold and/or the second threshold pre-defined or configured by at least one of RRC and MAC CE and DCI. Here, the minimum value of P1 can be 1, and the maximum value of P1 can be the number of reference signals in the Yi set, where i represents a cell different from the serving cell and the value of i is based on the number of candidate cells.

Event-6: This event occurs when a number of RSRP values (denoted as P2 values) measured for a second RS set (denoted as X) that is associated with the serving cell is smaller than or equal to a first threshold, and/or a number of RSRP values (denoted as P1 values) corresponding to the reference signals within a first RS set (denoted as Yi) associated with one or more identifications corresponding to candidate cells that is different from the serving cell is greater than or equal to a second threshold. The first threshold and/or the second threshold pre-defined or configured by at least one of RRC and MAC CE and DCI. Here, P2 can be an integer greater than or equal to 1. The maximum value of P2 can be the number of references signals in the set. The minimum value of P1 can be 1, and the maximum value of P1 can be the number of reference signals in the Yi set, where i represents a cell different from the serving cell and the value of i is based on the number of candidate cells.

Event-7: This event occurs when a number of RSRP values (denoted as P2 values) measured for a second RS set (denoted as X) that is associated with the serving cell is smaller than or equal to a first threshold, and/or at least one RSRP value from a first RS set (denoted as Yi) associated with one or more identifications corresponding to candidate cells that is different from the serving cell is greater than or equal to a second threshold. Here, P2 can be an integer greater than or equal to 1. The maximum value of P2 can be the number of references signals in the set, where i represents a cell different from the serving cell and the value of i is based on the number of candidate cells. The first threshold and/or the second threshold can be pre-defined or configurable by at least one of RRC, MAC CE and/or DCI.

Event-8: This event occurs when a number of RSRP values (denoted as P1 values) corresponding to the reference signals within a first RS set (denoted as Yi) associated with one or more identifications corresponding to candidate cells that is different from the serving cell for inter-DU or CU is greater than or equal to a threshold. Here, the minimum value of P1 can be 1, and the maximum value of P1 can be the number of reference signals in the Yi set, where i represents a cell different from the serving cell for inter-DU or CU and the value of i is based on the number of candidate cells. The threshold can be pre-defined or configurable by at least one of RRC, MAC CE, and/or DCI.

Event-9: This event occurs when a number of RSRP values (denoted as P2 values) measured for a second RS set (denoted as X) that is associated with the serving cell for inter-DU or CU are smaller than or equal to a first threshold, and/or a number of RSRP values (denoted as P1 values) corresponding to the reference signals within a first RS set (denoted as Yi) associated with one or more identifications corresponding to candidate cells that is different from the serving cell for inter-DU or CU is greater than or equal to a second threshold. Here, P2 can be an integer greater than or equal to 1. The maximum value of P2 can be the number of references signals in the set from inter-DU or CU. The minimum value of P1 can be 1, and the maximum value of P1 can be the number of reference signals in the Yi set, where i represents a cell different from the serving cell and the value of i is based on the number of candidate cells. The first threshold and the second threshold can be pre-defined or configurable by at least one of RRC, MAC CE, and/or DCI.

Event-10: This event occurs when a number of times that another event (e.g., one of Event-1 to Event-9 or other types of events) has occurred (consecutively or non-consecutively) is greater than or equal to a threshold. The threshold can be pre-defined or configurable by at least one of RRC, MAC CE and/or DCI.

Event-11: This event occurs when a number of times another event (e.g., one of Event-1 to Event-9 or other types of events) has occurred (consecutively or non-consecutively) is greater than or equal to a first threshold and smaller than or equal to a second threshold. The first threshold and/or the second threshold can be pre-defined or configurable by at least one of RRC, MAC CE and/or DCI.

Event-12: This event occurs when a timer expires. As discussed above, the timer can be used to control UE reporting of the measurement results. In some embodiments, the duration of timer, whether the timer is enabled/disabled, the period of the timer, etc. can be fixed or configurable by at least one of RRC, MAC CE, DCI. If some of the configurable timer parameters are not configured, default values can be applied (e.g., the default timer period, duration, etc.)

The example events can be also extended for serving cell and/or candidate cell(s) from intra-DU, inter-DU intra-CU, inter-DU inter-CU, and/or other scenarios. Taking inter-DU and Event-1 as an example, Event-1 for inter-DU can be extended as follows:

Case-1: The event occurs when a number of RSRP values (denoted as P1 values) corresponding to the reference signals within a first RS set (denoted as Yi) having an identification that is different from the DU of serving cell are greater than a RSRP value measured for a specified RS in a second RS set (denoted as X) that is associated with the serving cell. The identification can be associated with different candidate cells having the same DU.

Case-2: The event occurs when a number of RSRP values (denoted as P1 values) corresponding to the reference signals within a first RS set (denoted as Yi) having an identification that is different from the DU of serving cell are greater than a RSRP value measured for a specified RS in a second RS set (denoted as X) that is associated with the serving cell. The identification can be associated with different candidate cells having different DUs.

Similar extensions can be applied to other scenarios (e.g., inter-DU intra-CU, inter-DU inter-CU).

### Embodiment 4

In some embodiments, a set of rules for at least one of measurement, reporting and candidate cell can be provided. At least one of the number of candidate targets to be measured and/or reporting, the number of RSs to be measured and/or reporting, the number of RS sets to be measured and/or reporting, the number of reporting for measurement and/or reporting, whether to enable group-based reporting, and/or the number of groups for reporting is predefined, configurable (e.g., via MAC, DCI, and/or RRC), or determined based on UE capability.

For example, for the group-based reporting, at least one of N reference signals, reference signal sets, and candidate targets and TAs can be included in a group. The group can further include the serving target (e.g., the serving cell). Each of the reference signals and/or reference signal sets can be associated with a candidate target and/or an identification corresponding to the candidate target. In some embodiments, the reporting can include M reporting contents from candidate target(s) and/or serving target(s), or Among the M reporting contents, L reporting contents can be from the serving target and (M-L) reporting contents can be from candidate target(s), where L is an integer greater than or equal to 1. Wherein, reporting contents comprises at least one of: RSRP, SINR, Timing Advance (TA), CSI-RS resource indicator (CRI), SSB resource indicator (SSBRI), Cell identification, triggering command.

In some embodiments, the UE can select a subset of the measurement or reporting configurations or candidate targets or groups or RS for a group or abort the measurement and/or reporting when the number of measurement configuration or the number of reporting configuration or the number of candidate target or the number of group or the number of RS in a group exceed the UE capability. The subset of the measurement or reporting configurations or candidate targets or groups or RS for a group can be indicated by the network. The subset of the measurement or reporting configurations or candidate targets or groups or RS for a group can also be determined by the UE based on custom implementations, historical statistics (e.g., past or current measurements), the RSs or RS sets corresponding to RSRP values that are smaller than a threshold, the principle of randomization, the potential moving trajectory of the UE, the best or worst principle, the first Y1 RSRP values, the last Y1 RSRP values, or an interval that is obtained by mod (the number of RS or RS set or reporting or group or beam in a group or candidate target, UE capability).

In some embodiments, for one cell, UE can report one or more RSs and/or measurement result. The cell can be a serving cell or a candidate cell that is different from serving cell. If the number of RSs to be reported or measured or for candidate target is larger than the UE capability, the UE can drop RS(s) having RSRP value(s) that are smaller than a threshold. For example, the RSRP values can be sorted and the last Y1 RSRP values can be dropped in the reporting. Alternatively, the best Y1 RSRP values or the first Y1 RSRP values can be reported. Y1 can be determined based on UE capability and/or the number of configured reporting or the number of measurement or the number of candidate target. In some embodiments, if the number of RSs to be reported or measured or for candidate target is larger than the number of RSRP values supported by the UE capability, the UE can drop the reporting entirely.

In some embodiments, group-based reporting can be supported. The number of RSs to be reported in a group can be fixed or configurable based on UE capability. Further, each RS in a group is from different RS sets associated with different cells. In some embodiments, the cell identifier or the identification information corresponding to the cell/cell group can be included in reporting.

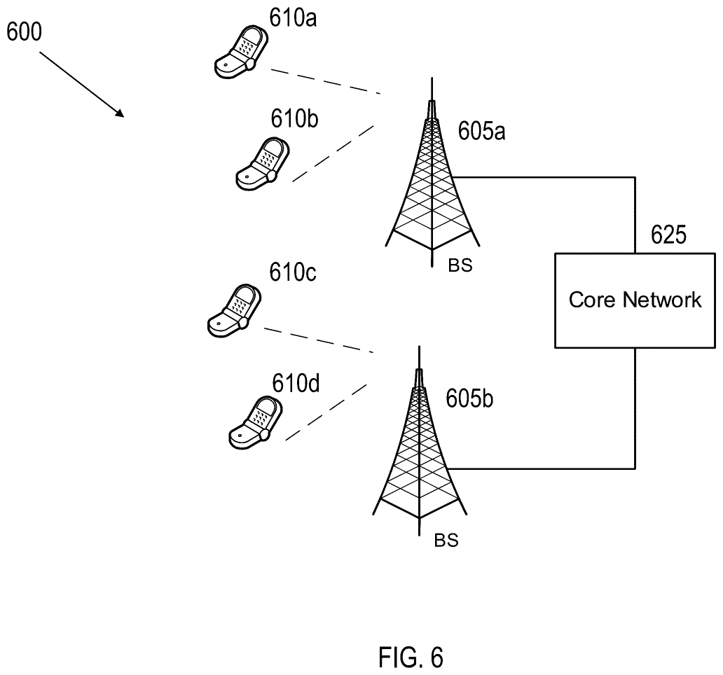

FIG. 6 shows an example of a wireless communication system 600 where techniques in accordance with one or more embodiments of the present technology can be applied. A wireless communication system 600 can include one or more base stations (BSs) 605a, 605b, one or more wireless devices (or UEs) 610a, 610b, 610c, 610d, and a core network 625. A base station 605a, 605b can provide wireless service to user devices 610a, 610b, 610c and 610d in one or more wireless sectors. In some implementations, a base station 605a, 605b includes directional antennas to produce two or more directional beams to provide wireless coverage in different sectors. The core network 625 can communicate with one or more base stations 605a, 605b. The core network 625 provides connectivity with other wireless communication systems and wired communication systems. The core network may include one or more service subscription databases to store information related to the subscribed user devices 610a, 610b, 610c, and 610d. A first base station 605a can provide wireless service based on a first radio access technology, whereas a second base station 605b can provide wireless service based on a second radio access technology. The base stations 605a and 605b may be co-located or may be separately installed in the field according to the deployment scenario. The user devices 610a, 610b, 610c, and 610d can support multiple different radio access technologies. The techniques and embodiments described in the present document may be implemented by the base stations of wireless devices described in the present document.

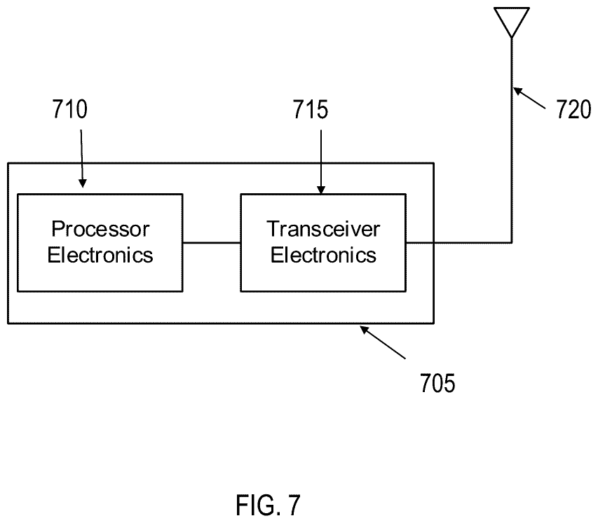

FIG. 7 is a block diagram representation of a portion of a radio station in accordance with one or more embodiments of the present technology can be applied. A radio station 705 such as a network node, a base station, or a terminal device or a wireless device (or a user device, UE) can include processor electronics 710 such as a microprocessor that implements one or more of the wireless techniques presented in this document. The radio station 705 can include transceiver electronics 715 to send and/or receive wireless signals over one or more communication interfaces such as antenna 720. The radio station 705 can include other communication interfaces for transmitting and receiving data. Radio station 705 can include one or more memories (not explicitly shown) configured to store information such as data and/or instructions. In some implementations, the processor electronics 710 can include at least a portion of the transceiver electronics 715. In some embodiments, at least some of the disclosed techniques, modules or functions are implemented using the radio station 705. In some embodiments, the radio station 705 may be configured to perform the methods described herein.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

1-27. (canceled)

28. A method of wireless communication comprising:
transmitting, by a network node to a terminal device, a Radio Resource Control (RRC) message including information configuring one or more candidate cells, a measurement configuration, or a reporting configuration; and
receiving, by the network node, a measurement result reported by the terminal device based on the RRC message.

29. The method of claim 28, wherein at least one of the information configuring the one or more candidate cells or the measurement configuration are configured outside of a configuration of a serving cell.

30. The method of claim 28, wherein a configuration of a candidate cell of the one or more candidate cells or a configuration corresponding to an identification of the candidate cell provides or configures at least one of: an RS configuration, a RS set configuration, a Transmission Configuration Indication (TCI) state configuration, or a random-access channel (RACH) configuration.

31. The method of claim 28, wherein a candidate cell of the one or more candidate cells or an identification corresponding to a candidate cell of the one or more candidate cells is associated with one or more Reference Signal (RS) resources included in the measurement configuration.

32. The method of claim 28, wherein a candidate cell of the one or more candidate cells or an identification corresponding to the candidate cell is associated with an RS resource set or an RS resource within the RS resource set.

33. The method of claim 28, wherein the reporting configuration configures at least one of:
a number of candidate cells, M, wherein M is an integer greater than or equal to 1;
whether to include reporting content of a serving cell;
a Resource Signal Receiving Power (RSRP);
a Signal to Interference plus Noise Ratio (SINR);
a CSI-RS resource indicator (CRI);
a SSB resource indicator (SSBRI); or
a cell identification.

34. The method of claim 33, wherein when the reporting content of the serving cell is included, the terminal device reports a measurement result from L serving cells and (M-L) candidate cells, wherein L is an integer greater than or equal to 1.

35. The method of claim 28, further comprising:
transmitting, by the network node to the terminal device, a MAC control element (MAC CE), wherein the MAC CE is used to activate or deactivate a Transmission Configuration Indicator (TCI) state associated with at least one of the one or more candidate cells.

36. A method of wireless communication comprising:
receiving, by a terminal device from a network node, a Radio Resource Control (RRC) message including information configuring one or more candidate cells, a measurement configuration, or a reporting configuration; and
performing, by the terminal device, a reporting of a measurement result based on receiving the RRC message.

37. The method of claim 36, wherein at least one of the information configuring the one or more candidate cells or the measurement configuration are configured outside of a configuration of a serving cell.

38. The method of claim 36, wherein the reporting configuration configures at least one of:
a number of candidate cells, M, wherein M in an integer greater than or equal to 1;
whether to include reporting content of serving cell;
a Resource Signal Receiving Power (RSRP);
a Signal to Interference plus Noise Ratio (SINR);
a CSI-RS resource indicator (CRI);
a SSB resource indicator (SSBRI); or
a cell identification.

39. The method of claim 38, wherein when the reporting content of the serving cell is included, the terminal device reports a measurement result from L serving cells and (M-L) candidate cells, wherein L is an integer greater than or equal to 1.

40. The method of claim 36, wherein a number of measurement configurations for the one or more candidate cells, or a number of reporting configurations for the one or more candidate cells is based on a capability of the terminal device.

41. An apparatus for wireless communication comprising a processor and a memory storing instructions, execution of which by the processor causes the apparatus to:
transmit, to a terminal device, a Radio Resource Control (RRC) message including: information configuring one or more candidate cells, a measurement configuration, or a reporting configuration; and
receive a measurement result reported by the terminal device based on the RRC message.

42. The apparatus of claim 41, wherein at least one of the information configuring the one or more candidate cells or the measurement configuration are configured outside of a configuration of a serving cell.

43. The apparatus of claim 41, wherein a candidate cell of the one or more candidate cells or an identification corresponding to a candidate cell of the one or more candidate cells is associated with one or more Reference Signal (RS) resources included in the measurement configuration.

44. The apparatus of claim 41, further caused to:
transmit, to the terminal device, a MAC control element (MAC CE), wherein the MAC CE is used to activate or deactivate a Transmission Configuration Indicator (TCI) state associated with at least one of the one or more candidate cells.

45. An apparatus for wireless communication comprising a processor and a memory storing instructions, execution of which by the processor causes the apparatus to:
receive, from a network node, a Radio Resource Control (RRC) message including: information configuring one or more candidate cells, a measurement configuration, or a reporting configuration; and
perform a reporting of a measurement result based on receiving the RRC message.

46. The apparatus of claim 45, wherein at least one of the information configuring the one or more candidate cells or the measurement configuration are configured outside of a configuration of a serving cell.

47. The apparatus of claim 45, wherein the reporting configuration configures at least one of:
a number of candidate cells, M, wherein M in an integer greater than or equal to 1;
whether to include reporting content of serving cell, wherein when the reporting content of the serving cell is included, the apparatus reports a measurement result from L serving cells and (M-L) candidate cells, wherein L is an integer greater than or equal to 1;
a Resource Signal Receiving Power (RSRP);
a Signal to Interference plus Noise Ratio (SINR);
a CSI-RS resource indicator (CRI);
a SSB resource indicator (SSBRI); or
a cell identification.
